(19) United States
(12) Patent Application Publication
(10) Pub. No.: US 2008/0189294 A1
(43) Pub. Date: Aug. 7, 2008

(54) METHOD AND APPARATUS FOR SHARING CONTENT

(75) Inventor: Soon-back CHA, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/861,362

(22) Filed: Sep. 26, 2007

(30) Foreign Application Priority Data
Feb. 2, 2007 (KR) 10-2007-0011194

(51) Int. Cl. G06F 17/30

(52) U.S. Cl. 707/10; 707/E17.001

(57) ABSTRACT

A method and apparatus for sharing contents are provided. The method includes receiving a download request for contents from a first client; confirming whether the contents required to be downloaded are stored or not; transmitting the contents when the contents are stored; and transmitting the location information of the contents when the contents are not stored.

### CROSS REFERENCE TO RELATED APPLICATION

This application claims priority from Korean Patent Application No. 10-2007-0011194 filed on Feb. 2, 2007, in the Korean Intellectual Property Office, the disclosure of which is incorporated herein by reference in its entirety.

### BACKGROUND OF THE INVENTION

1. Field of the Invention

Methods and apparatuses consistent with the present invention relate to a technology for sharing contents, and more particularly, to a method and apparatus for efficiently sharing contents that are created and held by individual persons.

2. Description of the Related Art

In recent years, Web 2.0 has attracted attention, and services using Web 2.0 have become popular. Web 2.0 is defined as a platform in which all people can use data in any programming or Internet environment without needing to save a large amount of data on their computers. On a website that only provides information and services, such as TVs or radios, it has been difficult to move saved data or available data on the website. However, if a Web 2.0 environment is constructed, data may move freely. A Web 2.0 conference was held in October 2005 by Tim O'Reilly, who is the Internet expert that leads technical trends in Silicon Valley. In this conference, an integration of flows of new services was named Web 2.0. If a representative service of Web 1.0 is a portal service, then Web 2.0 means it is the platform. In the portal service, users cannot freely use data, but the users can freely use data when using Web 2.0 as the platform. A representative example of the Web 2.0 is a blog.

Using Web 2.0 based services, users who only receive data passively can create contents and provide the contents to other Internet users, or provide contents held by the users to other users. When contents (UCC; User Created Contents) created by the users or contents held by the users are provided to other users, two methods are mainly used.

According to a first method, a service provider server collects UCCs or contents held by users and stores them so as to provide them to other Internet users, such that other Internet users may access the service provider server that holds the UCCs or contents to download them through computers.

FIG. 1 is a diagram illustrating an example of a method of sharing contents using a service provider server according to the related art.

Referring to FIG. 1, a first client 210, that wants to provide contents 101 to the other clients 220, 230, and 240, uploads the contents 101 to one server 110 among servers 110, 120, and 130 that are included in a service provider server 100. In addition, the first server 110 that has received the contents 101 confirms whether a user of the first client 210 is a qualified user or not, and when it is confirmed that the user of the first client 210 is a qualified user, the first server 110 stores the contents 101 that has been registered by the first client 210.

Therefore, the second to N-th clients 220, 230, and 240 may access the first server 110, search the contents 101 that are stored in the first server 110, and download necessary contents 102.

In order to distribute a load of the server, the service provider server 100 may include the plurality of servers 110, 120, and 130. However, sharing user created contents by using the service provider server 100 may give a load to the service provider server 110 in a case of when the service provider server 100 manages the plurality of servers 110, 120, and 130.

For example, on the assumption that one server manages 100 users and starts to provide a service, if the service becomes popular after the service is provided and 1000 users simultaneously access one server, it is not possible to manage download requests from the users using only one server that provides the service. Accordingly, the service provider needs to provide additional servers so as to securely manage download requests of the 1000 users that simultaneously access one server.

A second method of sharing contents with other users is to use a peer-to-peer (P2P) system. Two types of P2P programs that are most widely used are a messenger and a file sharing program. The messenger and the file sharing program may be discriminated according to a location where contents are stored, that is, may be discriminated according to whether the server intervenes or not.

In the messenger, a server has a friend directory, and when a user performs a login-in operation, the messenger displays the friend directory. In the case of the file sharing program, the server intervenes in file exchange when the server collects file lists and applies a searching process. That is, the server provides various factors enabling files to be shared between users. In addition, the users can exchange the files with each other by using various factors (for example, IP addresses or the like) provided by the server.

In the case where the server does not intervene, various algorithms are used. However, this case is the same as the case where the server intervenes in that individual users have distributed file lists.

FIG. 2 is a conceptual diagram illustrating an example of a method of sharing contents by using a P2P system according to the related art.

Referring to FIG. 2, a first client 210 stores information of a UCC or contents held by the first client 210 in one server 110 among servers 110, 120, and 130 that are provided in a service provider server 100. At this time, the first server 110 confirms whether a user of the first client 210 is a qualified user or not, and when it is confirmed that the user of the first client 210 is the qualified user, the first server 110 stores contents received from the first client 210.

When an N-th client 240 among the other clients 220, 230, and 240 that exist on the network requests the service provider server 100 to search desired contents, one server 110 among the servers 110, 120, and 130 that are provided in the user server 100 informs the N-th client of a list of contents, which the N-th client 240 wants to download, and a location 201 of the client (first client) 210 holding the corresponding contents. Therefore, the N-th client 240 directly accesses the first client 210 and downloads the desired contents 202 from the first client 210.

When the peer-to-peer (P2P) system is used, many users simultaneously accessing the first client 210 may give a load to the first client 210, and service quality of the contents provided to the other clients 220, 230, and 240 cannot be ensured.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An object of the present invention is to provide a method and apparatus for sharing contents in which when the number of times contents are requested to be downloaded is less than a predetermined number of times, location information of the contents is stored and provided to a user, and when the number of times contents are requested to be downloaded is greater than the predetermined number of times, the contents are stored in a server and the server directly provides the contents to the users, thereby improving quality of a service.

Objects of the present invention are not limited to those mentioned above, and other objects of the present invention will be apparently understood by those skilled in the art through the following description.

According to one aspect of the present invention, there is provided a method of sharing contents, the method comprising receiving a download request for contents from a first client, confirming whether the contents required to be downloaded are stored in a server or not, and transmitting the contents or location information of the contents according to whether the contents are stored in the server or not.

According to another aspect of the present invention, there is provided an apparatus for sharing contents, the apparatus comprising an interface unit which receives a download request for contents from a first client, a control unit which confirms whether the contents required to be downloaded are stored in the apparatus or not, and a transmitting unit which transmits the contents or location information of the contents according to whether the contents are stored in the apparatus or not.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating an example of a method of sharing contents using a service provider server according to the related art;

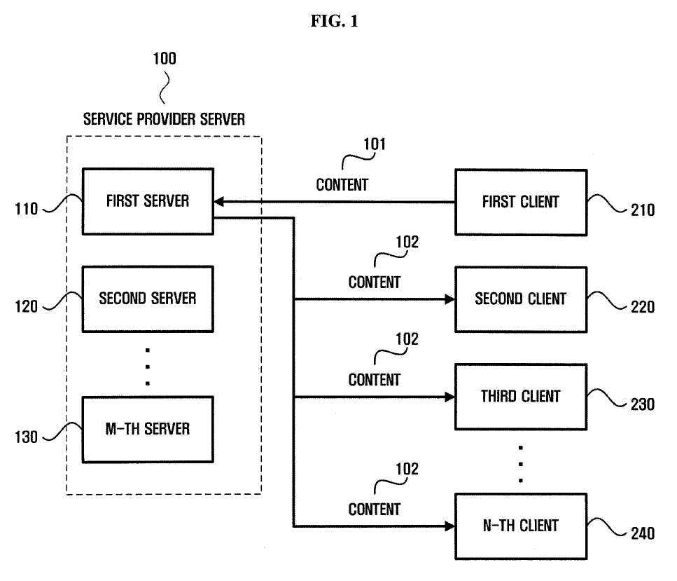

FIG. 2 is a conceptual diagram illustrating a method of sharing contents using a P2P system according to the related art;

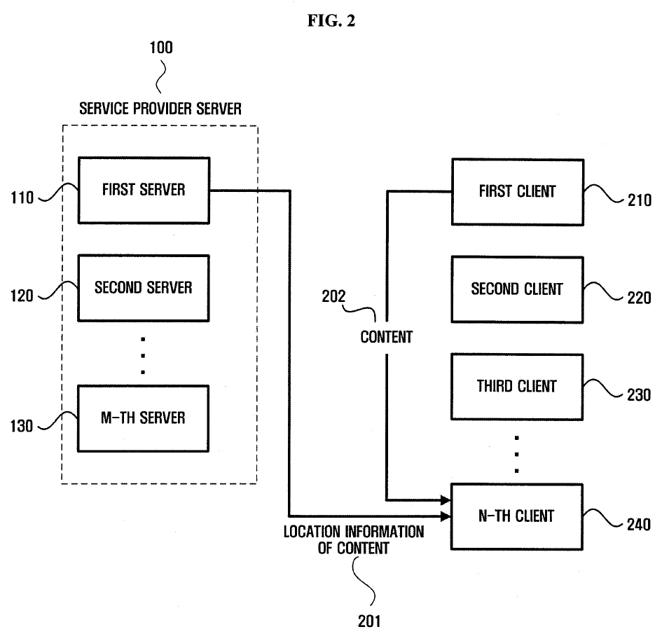

FIG. 3 is a conceptual diagram illustrating a method of sharing contents according to an exemplary embodiment of the present invention;

FIG. 4 is a block diagram illustrating an apparatus for sharing contents according to an exemplary embodiment of the present invention;

FIG. 5 is a diagram illustrating a process in which a content requesting client receives contents from a content providing client in accordance with an exemplary embodiment of the present invention;

FIG. 6 is a diagram illustrating a process in which a content requesting client receives contents from a server in accordance with an exemplary embodiment of the present invention;

FIG. 7 is a flowchart illustrating a process in which meta information is stored in an apparatus for sharing contents in accordance with an exemplary embodiment of the present invention;

FIG. 8 is a flowchart illustrating a process in which a content requesting client receives contents from a content providing client in accordance with an exemplary embodiment of the present invention; and

FIG. 9 is a flowchart illustrating a process of storing and deleting contents according to the number of times the contents are requested to be downloaded is requested in accordance with an exemplary embodiment of the present invention.

### DESCRIPTION OF THE EXEMPLARY EMBODIMENTS OF THE INVENTION

Advantages and features of the present invention and methods of accomplishing the same may be understood more readily by reference to the following detailed description of the exemplary embodiments and the accompanying drawings. The present invention may, however, be exemplary embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention will only be defined by the appended claims. Like identification codes refer to like elements throughout the specification.

The present invention will be described hereinafter with reference to block diagrams or flowchart illustrations of a method and apparatus for sharing contents according to exemplary embodiments thereof.

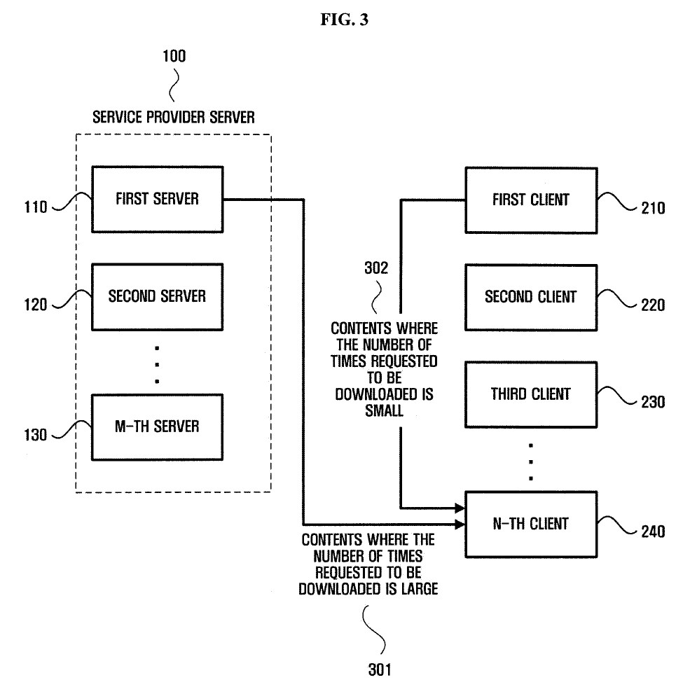

FIG. 3 is a conceptual diagram illustrating a method of sharing contents according to an exemplary embodiment of the present invention.

Referring to FIG. 3, a first client 210 that has contents for the first client 210 to want to share with the other clients accesses a service provider server 100 that provides a sharing service and stores user created contents (UCC) or the contents held by the first client 210 into the service provider server 100. The contents are stored by inputting meta information for the contents to the service provider server 110.

The meta information for the contents includes information that is associated with a title of the contents, a keyword representing the contents, a genre of the contents, or the like. Among servers 110, 120, and 130 of the service provider server 100, the first server 110 that wants to store contents confirms whether a user of the first client 210 is a qualified user or not. When it is determined that the user of the first client 210 is the qualified user, the first server 110 stores the contents registered by the first client 210.

The contents may be stored in a local storage device of the first client 210, and meta information for the contents, identification information of the first client 210, and location information for the first client 210 are stored in the first server 110.

An N-th client 240 among clients 220, 230, and 240 on the network, which wants to download the contents held by the first client 210, accesses one server 110 among the servers 110, 120, and 130 that are provided in the service provider server 100. The N-th client 240 that accesses the first server 110 requests the first server 110 to search desired contents. The first server 110 determines whether a user of the N-th client 240 is a qualified user or not, and when it is determined by the first server 110 that the user of the N-th client 240 is a qualified user, the first server 110 provides a list requested by the N-th client 240 in response to the request of the N-th client 240.

The N-th client 240 that is provided with the list selects the desired contents from the list and transmits selected information to the first server 110. The first server 110 that has received the selected information from the N-th client 240 confirms whether the first server 100 stores the contents requested to be downloaded from the N-th client 240.

As the result of confirmation, when the first server 110 stores the corresponding contents, the first server 110 provides the contents stored in the first server 110 to the N-th client 240 that has requested to download the contents. In contrast, as the result of confirmation, when the first server 110 does not store the corresponding contents, the first server 110 transmits to the N-th client 240, location information of the first client 210 that stores the contents requested by the N-th client 240 to be downloaded.

The N-th client 240 receives from the first server 110, the location information of the first client 210 that stores the contents requested by the N-th client 240 to be downloaded. Then, the N-th client 240 accesses the first client 210 using the received location information and can download the desired contents from the first client 210. The first server 110 counts the number of times the contents are requested to be downloaded.

As the result of count, when the number of times download is requested for the specific contents is not less than the specified number of times, it can be determined that the corresponding contents are popular. Accordingly, the first server 110 receives the corresponding contents from the client that stores the contents, and stores them. The first server 110 may request the client storing the corresponding contents to allow the contents to be stored in the first server 110.

When the first server 110 receives a response message from the client storing the corresponding contents indicating that the client allows the corresponding contents to be stored in the first server 110, the first server 110 stores the corresponding contents. Then, when the other clients 220, 230, and 240 request to download the corresponding contents, the first server 110 directly provides the corresponding contents 310 to the other clients 220, 230, and 240, thereby ensuring quality of service (QoS).

Meanwhile, when the number of times download is requested for the contents stored in the first server 110 is less than the specified number of times, it can be determined that the corresponding contents are unpopular. Accordingly, the first server 110 deletes the corresponding contents that are stored in the first server 110. Then, when the other clients 220, 230, and 240 requests the first server 110 to download the corresponding contents, the first server 110 provides the location information of the first client 210 holding the corresponding contents 302 to the other clients 220, 230, and 240 such that the other clients 220, 230, and 240 directly download the corresponding contents from the first client 210. The first server 110 can send a message indicating that the first server 110 wants to delete the corresponding contents 302 to the first client 210 having provided the corresponding contents 302.

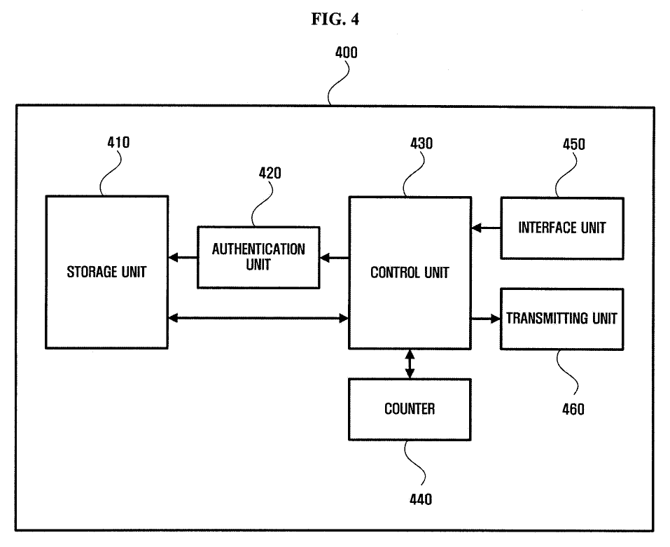

FIG. 4 is a block diagram illustrating an apparatus for sharing contents according to an exemplary embodiment of the present invention. The apparatus for sharing contents shown in FIG. 4, that is, a server 400 includes a storage unit 410, an authentication unit 420, a control unit 430, a counter 440, an interface unit 450, and a transmitting unit 460.

The storage unit 410 stores contents, meta information of the contents, and client information that have been received from the client. The storage unit 410 is a module in which information can be input or output, such as a hard disk, a flash memory, a compact flash card (CF card), a secure digital card (SD card), a smart media card (SM card), a multimedia card (MMC) or a memory stick. The storage unit 410 may be included in the apparatus for sharing contents or a separate device.

The authentication unit 420 determines whether contents provided by clients conform to a policy of the service provider server 100. For example, when the policy of the service provider server 100 prohibits violent or lascivious materials from being shared, the authentication unit 420 confirms whether the corresponding contents are the violent or lascivious materials. At this time, in order to determine whether the contents conform to the policy of the service provider server 100, the authentication unit 420 may refer to the meta information.

The control unit 430 confirms whether the contents are stored when the contents are requested to be downloaded. That is, the control unit 430 confirms whether the requested contents are stored in the storage unit 410. In addition, the control unit 430 transmits the contents or a location where the contents are stored through the transmitting unit 460 according to whether the contents are stored in the storage unit 410.

Further, the control unit 430 determines the number of times contents are requested to be downloaded updated by the counter 440, determines the location where the contents are stored, and performs whole control on the storage unit 410, the authentication unit 420, the counter 440, the interface unit 450, the transmitting unit 460, and the server 400.

The counter 440 updates the number of times the contents are requested to be downloaded that has been received through the interface unit 450. At this time, the counter 440 may confirm and update the number of times individual contents are requested to be downloaded for a specified period with a specified cycle. For example, it is assumed that the counter 440 confirms the number of times the contents are requested to be downloaded for 24 hours with a period of one hour. Further, it is assumed that the number of times the contents are requested to be downloaded from twelve o'clock to one o'clock p.m. in the first day is ten times and the number of times the contents are requested to be downloaded from one o'clock p.m. in the first day to twelve o'clock in the second day is one hundred times. Thus, the number of times the contents are requested to be downloaded until twelve o'clock in the second day is 110 times. When it is assumed that the number of times the individual contents are requested to be downloaded from twelve o'clock to one o'clock p.m. in the second day is five times, the number of times the contents are requested to be downloaded from one o'clock p.m. in the first day to one o'clock p.m. in the second day becomes 105 times.

The number of times the individual contents are requested to be downloaded, which is updated by the counter 440, may be stored in the storage unit 410.

The interface unit 450 communicates with the client that wants to share the contents with the other clients and receives the contents.

Further, the transmitting unit 460 communicates with the client that requests the contents and transmits the contents or location information of the contents. The location information of the contents includes location information of the client that stores the contents.

FIG. 4 shows a case where the interface unit 450 and the transmitting unit 460 are provided as separate modules. However, the present invention is not limited thereto, and one communication module may function as the interface unit 450 and the transmitting unit 460.

The communication method between the interface unit 450 or the transmitting unit 460 and the client may be a wire communication method, such as Ethernet, a USB, IEEE 1394, serial communication, and parallel communication, and may be a wireless communication method, such as infrared communication, Bluetooth, home RF, and a wireless LAN.

A client that wants to share contents (hereinafter, referred to as content providing client) 600 includes an interface unit through which the client can access the server 400, and a storage unit that stores contents for the client to want to share with the other clients.

The content providing client 600 accesses the server 400 through the interface unit and is subjected to an authentication process. This process is the same as a common log-in process.

The content providing client 600 that has completed the log-in process transmits meta information for the contents which the content providing client 600 wants to share with the other clients to the server 400. The meta information includes at least one of a title, a keyword, and a genre of the contents. The authentication unit 420 of the server 400 receives the meta information for the contents and confirms whether the corresponding contents conform to a policy of the service provider server 100 by using the received meta information. The process of confirming whether the contents conform to the policy of the service provider server 100 is not essential but may be omitted according to the policy of the service provider server 100.

If the process of confirming whether the contents conform to the policy of the service provider server 100 is completed, the control unit 430 stores the meta information for the contents and the information for the content providing client 600 in the storage unit 410, and informs the content providing client 600 that the received information (meta information and information for the content providing client) is successfully stored or the received meta information cannot be stored according to the policy of the service provider server 100.

The information for the content providing client 600 includes information for identification and a location of the content providing client 600. When the contents are requested to be downloaded from the other clients, the location information of the content providing client 600 may be provided to the client that requests to download the contents.

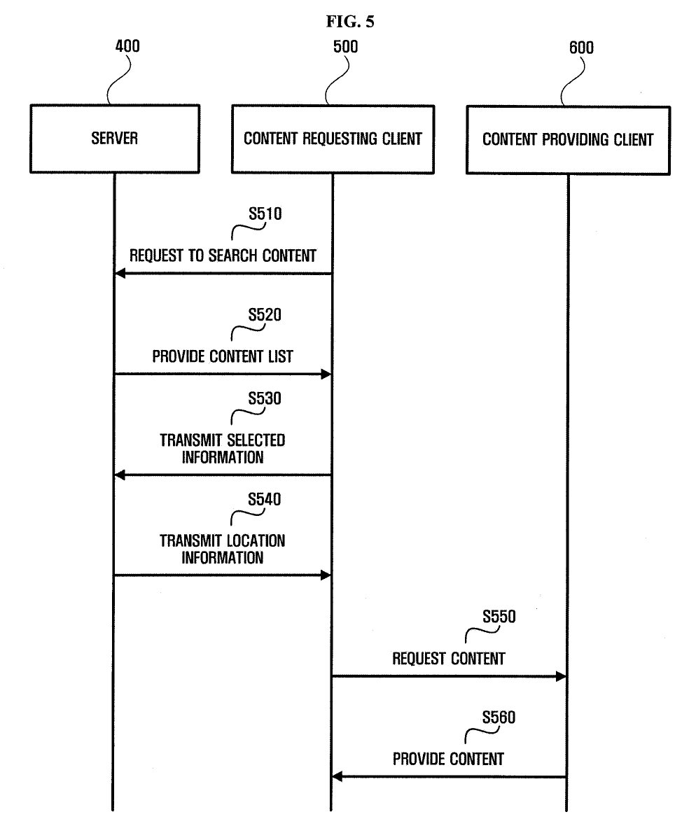

FIG. 5 is a diagram illustrating a process in which a content requesting client receives contents from a content providing client in accordance with an exemplary embodiment of the present invention.

A content requesting client 500 includes an interface unit that allows the content requesting client 500 to access a server 400 or a content providing client 600 through a network, and a storage unit that stores the contents downloaded from the content providing client 600.

The content providing client 500 that wants to download specified contents, accesses the server 400 and is subjected to an authentication process. This process is the same as a common log-in process.

The content requesting client 500 that has been subjected to the authentication process requests the server 400 to search desired contents (Operation S510). The server 400 that receives the request to search the contents transmits a list of the requested contents to the content requesting client 500 (Operation S520). At this time, the list of the contents may include not only the list of the contents stored in the storage unit 410 but also meta information. The content requesting client 500 that has received the list of the contents receives a selection command for the contents from a user, and transmits content selection information according to the input selection command to the server 400 (Operation S530).

The control unit 430 of the server 400 receives the content selection information and confirms whether the contents corresponding to the selected information are stored in the storage unit 410. At this time, the counter 440 counts the number of times the corresponding contents are requested to be downloaded and separately stored.

As the result of confirmation on whether the contents are stored in the storage unit 410, when it is confirmed that the corresponding contents are not stored in the storage unit 410, the control unit 430 transmits location information of the content providing client 600 that holds the corresponding contents to the content requesting client 500 through the transmitting unit 460 (Operation S540).

Then, the content requesting client 500 receives the location information of the content providing client 600 that holds the corresponding contents. Then, the content requesting client 500 directly accesses the content providing client 600 so as to request to download the corresponding contents (S550), and is supplied with the corresponding contents from the content providing client 600 (Operation S560).

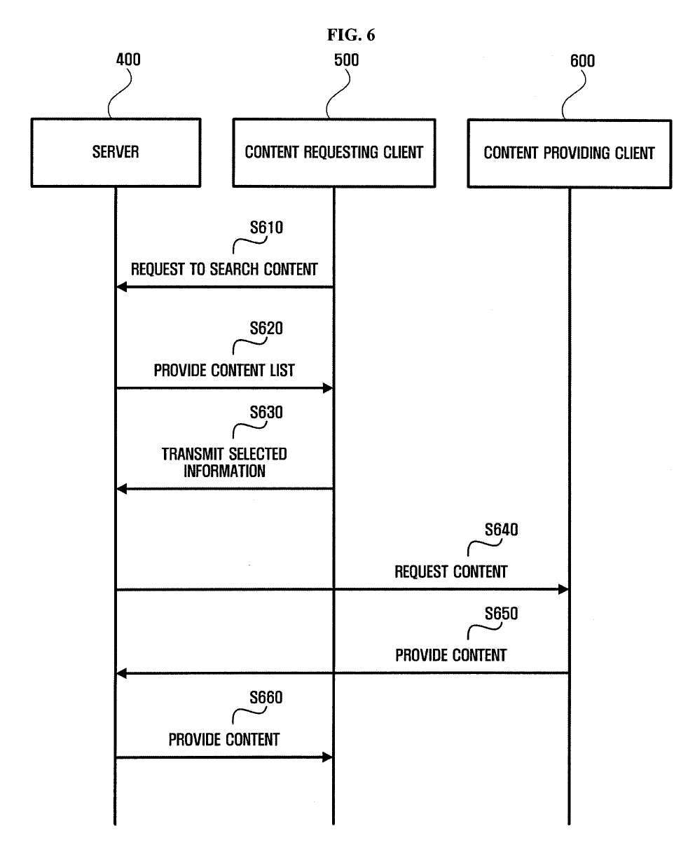

FIG. 6 is a diagram illustrating a process in which a content requesting client receives contents from a server in accordance with an exemplary embodiment of the present invention.

Referring to FIG. 6, whenever the contents are requested to be downloaded from the content requesting client 500, the counter 440 counts the number of times the corresponding contents are requested to be downloaded, and updates it.

When the number of times the corresponding contents is requested to be downloaded exceeds the specified number of times, the control unit 430 can determine that the corresponding contents are popular. The control unit 430 requests the content providing client 600 holding the corresponding contents to transmit the corresponding contents.

The content providing client 600 that receives the content transmission request from the server 400 transmits the corresponding contents to the server 400. In this process, the content providing client 600 may reject the content transmission request from the server 400 and directly transmit the corresponding contents to the content requesting client 500 according to the existing method. That is, the content providing client 600 may not allow the corresponding contents to be stored in the storage unit 410 of the server 400.

Further, the control unit 430 may request the content providing client 600 to transmit the corresponding contents, but may acquire the corresponding contents stored in the content providing client 600 by using the location information of the content providing client 600 that is stored in advance in the storage unit of the server 400.

Then, the content requesting client 500 that has requested to download the corresponding contents accesses the server 400 and is subjected to an authentication process. The content requesting client 500 on which the authentication process is completed requests to search the contents (Operation S610).

The server 400 that has been requested to search the contents provides the list of the contents held by the server 400 to the content requesting client 500 (Operation S620). The list of the contents may include not only the contents stored in the storage unit 410 but also the meta information.

The content requesting client 500 that has received the list of the contents from the server 400 transmits selection information on specific contents to the server 400 (Operation S630). The control unit 430 that has received the selection information from the content requesting client 500 confirms whether the corresponding contents are stored in the storage unit 410. The counter 440 counts the number of times the corresponding contents are requested to be downloaded and separately store it. As the result of confirmation, when it is confirmed that the corresponding contents are stored in the storage unit 410, the control unit 430 extracts the corresponding contents from the storage unit 410, and transmits the corresponding contents to the content requesting client 500 through the transmitting unit 460.

When the number of times the contents stored in the storage unit 410 are requested to be downloaded is less than the predetermined number of times, the control unit 430 regards the corresponding contents as unpopular contents and may delete the corresponding contents. For example, after the control unit 430 confirms the number of times the specific contents are requested to be downloaded during a specific period, when the number of times the specific contents are requested to be downloaded is less than the specific number of times, the control unit 430 deletes the corresponding contents in the storage unit 410.

Meanwhile, even though the contents are deleted, the location information of the content providing client 600 that holds the contents may be continuously stored in the storage unit 410. As a result, when receiving the download request for the contents deleted in the storage unit 410, the control unit 430 requests the content providing client 600 to provide the contents that are requested to be downloaded from the content requesting client 500 by using the location information of the content providing client 600 that holds the corresponding contents (Operation S640).

Therefore, the content providing client 600 transmits the corresponding contents to the server 400 (Operation S650), and the server 400 transmits the received contents to the content requesting client 500 (Operation S660).

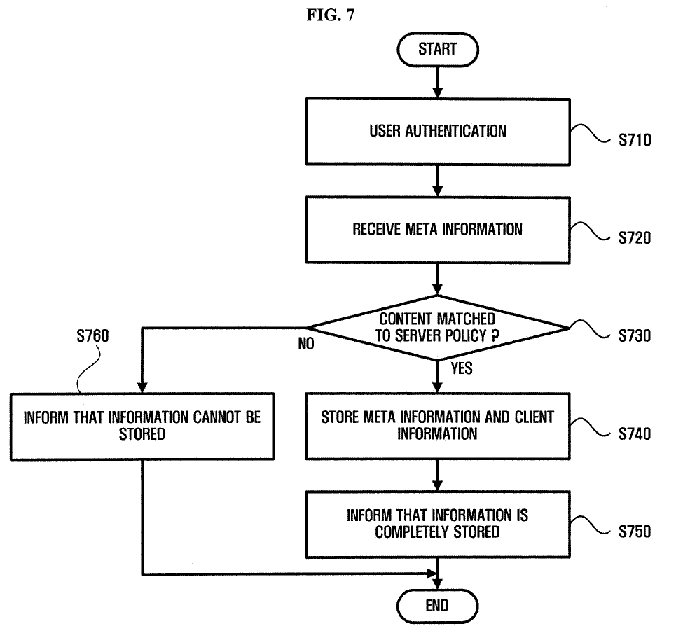

FIG. 7 is a flowchart illustrating a process in which meta information is stored in an apparatus for sharing contents in accordance with an exemplary embodiment of the present invention.

Referring to FIG. 7, when the server 400 receives authentication information from the content providing client 600 that wants to share the held contents with the other clients, the server 400 authenticates whether a user of the content providing client 600 is a qualified user (Operation S710). The authentication process may be the same as a common log-in process.

When it is authenticated that the user of the content providing client 600 is the qualified user, the server 400 receives from the content providing client 600, meta information on the contents which the content providing client 600 wants to share with the other clients (Operation S720). In this case, the meta information for the contents includes at least one of a title, a keyword, and a genre of the contents.

The server 400 that has received the meta information confirms whether the corresponding contents conform to a policy of the service provider server 100, on the basis of the received meta information (Operation S730). For example, when the policy of the service provider server prohibits violent or lascivious materials from being shared, the server confirms whether the corresponding contents are the violent or lascivious materials. The process of confirming whether the contents conform to the policy of the service provider server 100 is not essential but may be omitted according to the policy of the service provider server 100.

As the result of confirming whether the contents conform to the policy of the service provider server 100, when the corresponding contents do not conform to the policy of the service provider server 100, the server 400 informs the content providing client 600 that the meta information for the corresponding contents cannot be stored (Operation S760). In contrast, as the result of confirming whether the contents conform to the policy of the service provider server 100, when the corresponding contents conform to the policy of the service provider server 100, the server 400 stores the meta information for the corresponding contents and the information for the content providing client 600 (Operation S740), and informs the content providing client 600 that the corresponding contents are successfully stored (Operation S750). The information for the content providing client 600 may include information for identification and a location of the content providing client 600.

When the contents are requested to be downloaded from the content requesting client 500, the location information of the content providing client 600 may be provided to the client 500 that requests to download the contents.

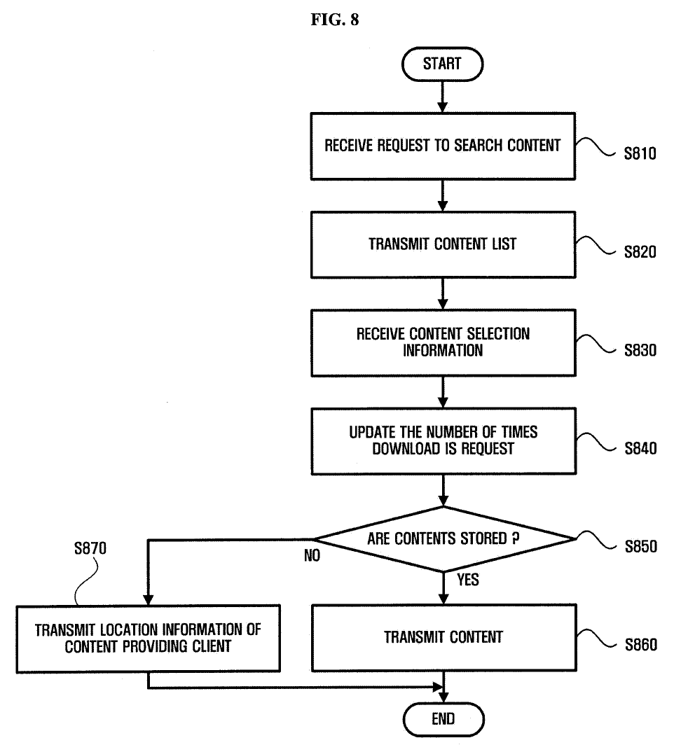

FIG. 8 is a diagram illustrating a process in which a content requesting client receives contents from a content providing client in accordance with an exemplary embodiment of the present invention.

Referring to FIG. 8, the server 400 receives a content search request from the content providing client 500 that wants to download the contents (Operation 810). Before this process, the content requesting client 500 accesses the server 400 and is subjected to an authentication process. The authentication process is the same as a common log-in process.

The server 400 that has been requested to search the contents transmits a list of the requested contents to the content requesting client 500 (Operation S820). At this time, the provided list of the contents may include not only the contents stored in the server 400 but also meta information.

Then, the server 400 receives the content selection information from the content requesting client 500 (Operation S830). Therefore, the server 400 updates the number of times the corresponding contents are requested to be downloaded through the counter 440, and separately stores it (Operation S840).

Then, the server 400 confirms whether the corresponding contents are stored in the storage unit 410, through the control unit 430 (Operation S850). As the result of confirmation, when the corresponding contents are stored in the storage unit 410, the control unit 430 extracts the corresponding contents from the storage unit 410, and transmits the extracted contents to the content requesting client 500 through the transmitting unit 460 (Operation S860). In contrast, as the result of confirmation, when the corresponding contents are not stored in the storage unit 410, the control unit 430 transmits the location information of the content providing client 600 that holds the corresponding contents to the content requesting client 500 through the transmitting unit 460 (Operation S870).

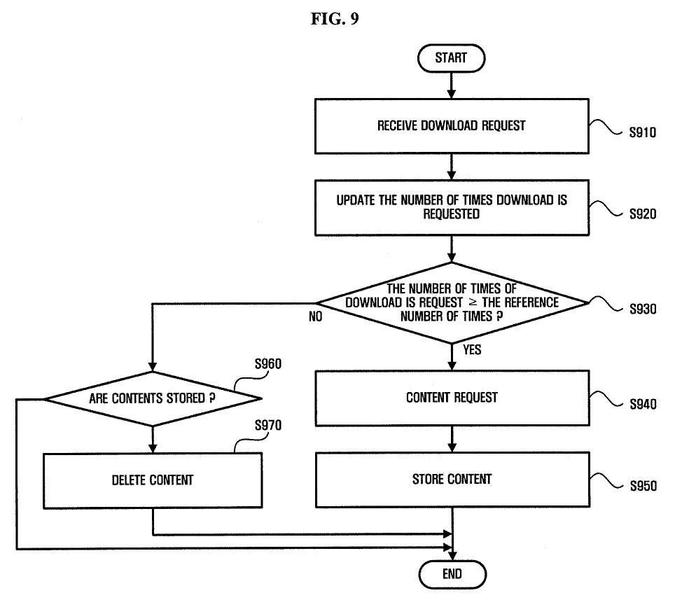

FIG. 9 is a flowchart illustrating a process of storing or deleting contents according to the number of times contents are requested to be downloaded in accordance with an exemplary embodiment of the present invention.

Referring to FIG. 9, the server 400 receives the content download request from the content requesting client 500 (Operation S910). Then, the counter 440 of the server 400 that has received the content download request updates the number of times the corresponding contents are requested to be downloaded and separately stores it (Operation S920).

The control unit 430 of the server 400 confirms whether the number of times the corresponding contents are requested to be downloaded is not less than the specified number of requests (Operation S930). As the result of confirmation, when the number of times the corresponding contents are requested to be downloaded is not less than the specified number of times, the corresponding contents can be determined as popular contents. Therefore, the control unit 430 requests the content providing client 600 that holds the corresponding contents to transmit the corresponding contents (Operation S940).

As a result, the contents that are transmitted by the content providing client 600 are stored in the storage unit 410 of the server 400 (Operation S950). Meanwhile, as the result of confirmation, when the number of times the corresponding contents are requested to be downloaded is less than the specified number of requests, the control unit 430 confirms whether the corresponding contents are stored in the storage unit 410 (Operation S960). At this time, when the corresponding contents are stored in the storage unit 410, the control unit 430 deletes the corresponding contents (Operation S970). Then, when the corresponding contents are requested to be downloaded, the control unit 430 provides the location information of the content providing client 600 that hold the corresponding contents.

At the time of determining whether to store or delete the corresponding contents, when the number of times the contents are requested to be downloaded is changed from less than the specified number of times to not less than the specified number of requests, the control unit 430 can allow the contents held by the content providing client 600 to be stored in the storage unit 410. In contrast, when the number of times the contents are requested to be downloaded is changed from not less than the specified number of times to less than the specified number of requests, the control unit 430 can make the contents stored in the storage unit 410 deleted.

Meanwhile, it can be understood by those skilled in the art that the scope of the method and apparatus for sharing contents according to an exemplary embodiment of the present invention includes a computer recordable recording medium having recorded therein program codes that allow a computer to execute the above-described method.

Although the present invention has been described in connection with the exemplary embodiments of the present invention, it will be apparent to those skilled in the art that various modifications and changes may be made thereto without departing from the scope and spirit of the present invention. Therefore, it should be understood that the above embodiments are not limitative, but illustrative in all aspects.

According to the method and apparatus for sharing contents according to the exemplary embodiment of the present invention, the following effects can be achieved.

Since the service provider that allows contents to be shared does not need to store all the contents, the service provider can efficiently manage the server with the low cost.

Further, the service provider that allows the contents to be shared directly transmits popular contents, thereby ensuring quality of service (QoS) of the popular contents used by many users.

Furthermore, general users download popular contents from the service provider server so as to overcome the limit of the P2P system depending a transmission speed according to the number of the users accessing the service provider server, and receive the popular contents at a high speed.

What is claimed is:

1. A method of sharing contents, the method comprising:
receiving a download request for contents from a first client;
confirming whether the contents required to be downloaded are stored in a server or not;
transmitting the contents when the contents are stored in the server; and
transmitting the location information of the contents when the contents are not stored in the server.

2. The method of claim 1, wherein the contents are stored in a storage unit when the number of times the contents are requested to be downloaded is not less than a specified number of requests, and are stored in a second client corresponding to the location information when the number of times the contents are requested to be downloaded is less than the specified number of requests.

3. The method of claim 2, wherein the storage unit stores meta information for the contents and information for the second client.

4. The method of claim 3, wherein the meta information for the contents comprises at least one of a title, a keyword, and a genre of the contents.

5. The method of claim 3, further comprising:
determining whether the contents are stored in the storage unit on the basis of the meta information.

6. The method of claim 5, wherein the meta information is used to determine if the content conforms to a policy of the server.

7. The method of claim 6, wherein the policy of the server prohibits the content to be shared to be violent or lascivious; and if the content is determined to be violent or lascivious based on the meta information, prohibiting storing of the contents in the server.

8. The method of claim 3, wherein the information for the second client comprises at least one of identification and location information of the second client.

9. The method of claim 2, further comprising:
receiving the contents stored in the second client, when the number of times the contents are requested to be downloaded is changed from less than the specified number of requests to not less than the specified number of requests.

10. The method of claim 2, further comprising:
deleting the contents stored in the storage unit, when the number of times the contents are requested to be downloaded is changed from not less than the specified number of requests to less than the specified number of requests.

11. The method of claim 2, further comprising:
confirming the number of times the contents are requested to be downloaded.

12. An apparatus for sharing contents, the apparatus comprising:
an interface unit which receives a download request for contents from a first client:
a control unit which confirms whether the contents required to be downloaded are stored in the apparatus or not;
a storage unit which stores contents; and
a transmitting unit which transmits the contents when the contents are stored in the storage unit, or transmits location information of the contents when the contents are not stored in the storage unit.

13. The apparatus of claim 12, wherein the contents are stored when the number of times the contents are requested to be downloaded is not less than the specified number of requests; and
the contents are stored in a second client corresponding to the location information when the number of times the contents are requested to be downloaded is less than the specified number of requests.

14. The apparatus of claim 13, wherein the storage unit stores meta information for the contents and information for the second client.

15. The apparatus of claim 14, wherein the meta information for the contents comprises at least one of a title, a keyword, and a genre of the contents.

16. The apparatus of claim 14, further comprising:
an authentication unit determining whether the contents are stored in the storage unit on the basis of the meta information.

17. The apparatus of claim 16, wherein the authentication unit uses the meta information to determine if the content to be shared conforms to a sharing policy.

18. The apparatus of claim 17, wherein the sharing policy of the apparatus prohibits the content to be shared to be violent or lascivious; and if the content is determined to be violent or lascivious based on the meta information, the control unit prohibits storing of the contents.

19. The apparatus of claim 14, wherein the information for the second client comprises at least one of identification and location information of the second client.

20. The apparatus of claim 13, wherein the control unit stores the contents stored in the second client in the storage unit, when the number of times the contents are requested to be downloaded is changed from less than the specified number of requests to not less than the specified number of requests.

21. The apparatus of claim 15, wherein the control unit deletes the contents stored in the storage unit, when the number of times the contents are requested to be downloaded is changed from not less than the specified number of requests to less than the specified number of requests.

22. The apparatus of claim 11, further comprising:
a counter confirming the number of times the contents are requested to be downloaded.

23. A method of receiving contents, the method comprising:
transmitting a content search request to a server;
receiving a content list in response to the request;
transmitting a content selection information to the server;
receiving one of a content or a location information from the server based on whether the contents are stored in the server;
wherein the server stores a content based on a number of download requests for the content.

24. The method of claim 23, wherein the contents are stored in the server when the number of times the contents are requested to be downloaded is greater than a specified number of requests.

25. The method of claim 24, wherein the contents are deleted when the number of times the contents are requested to be downloaded is changed from greater than the specified number of requests to less than the specified number of requests.
